(19) United States
(12) Patent Application Publication
(10) Pub. No.: US 2007/0229609 A1
(43) Pub. Date: Oct. 4, 2007

(54) Inkjet printhead with backflow restrictor

(75) Inventors: Min-soo Kim, Seoul (KR); Keon Kuk, Yongin-si (KR); Bang-weon Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/604,778

(22) Filed: Nov. 28, 2006

(30) Foreign Application Priority Data
Mar. 28, 2006 (KR) 2006-28026

(51) Int. Cl. B41J 2/17

(52) U.S. Cl. 347/84

(57) ABSTRACT

An inkjet printhead includes an ejecting portion including an ink chamber to store ink, a nozzle to eject the ink stored in the ink chamber, and an actuator to generate an ink ejecting force, a supplying portion to refill the ink chamber with ink, a connecting portion to connect the ejecting portion and the supplying portion, and a backflow restrictor formed at the connecting portion to create a higher flow resistance against an ink backflow to the supplying portion than against an ink refill flow to the ejecting portion, the backflow restrictor including an converging region and an expansion region that are sequentially formed.

### CROSS-REFERENCE TO RELATED APPLICATIONS

This application claims priority under 35 U.S.C. §119(a) from Korean Patent Application No. 10-2006-0028026, filed on Mar. 28, 2006, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to an inkjet printhead that prevents backflow of ink effectively and has high energy efficiency.

2. Description of the Related Art

Inkjet printers print an image having a predetermined color on a printing medium by ejecting ink droplets onto a desired region of the printing medium. Such inkjet printers include an inkjet printhead for ejecting ink onto the printing medium. The inkjet printhead can be classified into a shuttle type inkjet printhead and an array type inkjet printhead.

The shuttle type inkjet printhead fires ink onto a printing medium while reciprocating in a perpendicular direction (hereinafter, referred to as a main scanning direction) to a feeding direction (hereinafter, referred to as a subsidiary scanning direction) of the printing medium. The shuttle type inkjet printhead includes a number of nozzles arranged in the subsidiary scanning direction to realize high speed printing. A length of the arrangement of the nozzles in the subsidiary scanning direction is equal to a swath width. While moving in the main scanning direction, the shuttle type inkjet printhead fires ink across a swath width at the same time, such that one swath image can be printed on the printing medium after the shuttle type inkjet printhead moves one time in the main scanning direction. In other words, while the shuttle type inkjet printhead moves in the main scanning direction, the shuttle type inkjet printhead fires ink onto the printing medium using the nozzles having a length corresponding to the swath width, such that a first swath image can be printed onto a first swath of the printing medium. Next, the printing medium is moved in the subsidiary direction by a length corresponding to the swath width and the shuttle type inkjet printhead returns to its original position where the shuttle type inkjet printhead faces a second swath. Then, the shuttle type printhead fires ink onto the printing medium as it moves in the main scanning direction, in order to print a second swath image onto the second swath of the printing medium.

The array type inkjet printhead includes a nozzle array having nozzles arranged in the main scanning direction. The nozzle array has a width corresponding to the width of a printing medium. Further, like in the shuttle type printhead, the nozzle array has a length corresponding to a swath width. In a state where the array type printhead and the printing medium are stationary, the nozzles of the nozzle array fire ink simultaneously to print a first swath image onto a first swath of the printing medium. After that, the printing medium is moved in the subsidiary scanning direction by a length corresponding to a swath width of the first swath to allow the array type inkjet printhead to face a second swath. Then, the nozzles of the array type inkjet printhead fire ink simultaneously to print the second swath image onto the second swath of the printing medium. The array type inkjet printhead can print an image onto a printing medium at a higher speed since only the printing medium is moved and the array type inkjet printhead fires ink at a fixed position.

FIG. 1 is a schematic view illustrating a conventional inkjet printhead, and FIG. 2 is a sectional view taken along line II-II′ of FIG. 1. Referring to FIGS. 1 and 2, the conventional inkjet printhead includes a substrate 10 having an ink feedhole 12, a chamber layer 20 stacked on the substrate 10, and a nozzle layer 30 stacked on the chamber layer 20. The chamber layer 20 includes a plurality of ink chambers 22 storing ink to be ejected and a plurality of restrictors 24 connecting the ink chambers 22 and the ink feedhole 12 for allowing ink flow therethrough. A common inlet 26 is formed between the restrictors 24 and the ink feedhole 12, and both ends 24a and 24b of each restrictor 24 are connected to the ink chamber 22 and the common inlet 26, respectively as an ink flow channel structure. The nozzle layer 30 includes a plurality of nozzles 32 for ink ejection. An actuator is formed at each ink chamber 22 for generating an ink-ejecting power. Examples of the actuator include a heater, a piezoelectric unit, a shape memory alloy, and a supersonic motor. In FIGS. 1 and 2, a heater 25 is formed on a bottom surface of each ink chamber 22 as an example of the actuator. The heater 25 produces a bubble in the ink stored in the ink chamber 22 by heating the ink. In detail, when ink is filled in the ink chamber 22, a current is applied to the heater 25 to heat the ink, thereby generating a bubble in the ink for ejecting the ink out of the ink chamber 22 through the nozzle 32 by the expansion of the bubble. After that, ink is supplied again to the ink chamber 22 from the ink feedhole 12 through the common inlet 26 and the restrictor 24. This ink flow will now be referred to as a refill flow of the ink.

However, in the above-described ink flow channel structure, when ink is ejected out of the chamber 22 by the expansion of the bubble, some ink flows reversely from the ink chamber 22 toward the ink feedhole 12 through the restrictor 24 (a backflow of the ink). Energy supplied to the heater 25 for ejecting the ink through the nozzle 32 is wasted by the backflow of the ink, decreasing the energy efficiency of the heater 25 and increasing the power consumption of the inkjet printhead. Further, since the heater 25 has to be driven more intensively, the reliability of the heater 25 decreases.

In the shuttle type inkjet printhead, since a number of nozzles are arranged in the subsidiary scanning direction in correspondence with a swath width, the problems regarding the ink backflow becomes more significant as the number of nozzles increases. Particularly, backflow problems are a much more significant consideration in the case of the array type inkjet printhead in which several tens of thousands of nozzles or more nozzles are arranged in the main scanning direction in correspondence with the width of the printing medium and in the subsidiary direction in correspondence with the swath width.

Further, since an amount of ink to be refilled in the ink chamber 22 from the ink feedhole 12 is determined as a sum of the ink ejected through the nozzle 32 and an amount of the ink backflow to the ink feedhole 12, the amount of ink to be refilled and a refill time increase as the backflow of the ink increases. The increase in the ink refill time results in decrease in a driving frequency of the inkjet printhead. As a result, a printing speed of the inkjet printhead decreases.

### SUMMARY OF THE INVENTION

The present general inventive concept provides an inkjet printhead that can operate at a higher frequency by restricting a backflow of ink and improving an energy efficiency of an actuator.

Additional aspects and advantages of the present general inventive concept will be set forth in part in the description which follows and, in part, will be obvious from the description, or may be learned by practice of the general inventive concept.

The foregoing and or other aspects of the present general inventive concept may be achieved by providing an inkjet printhead including an ejecting portion including an ink chamber to store ink, a nozzle to eject the ink stored in the ink chamber, and an actuator to generate an ink ejecting force, a supplying portion to refill the ink chamber with ink, a connecting portion to connect the ejecting portion and the supplying portion, and a backflow restrictor formed at the connecting portion to create a higher flow resistance against an ink backflow to the supplying portion than against an ink refill flow to the ejecting portion, the backflow restrictor including a converging region and an expansion region that are sequentially formed, the converging region gradually converging toward the supplying portion, the expansion region suddenly expanding toward the supplying portion when compared with the converging region.

The backflow restrictor may further include another converging region, and the expansion region may be formed between the converging regions and may have a steeper slope than that of the converging regions.

The backflow restrictor may exhibit a non-linearity and an anisotropic property when a volume flow of the ink through the connecting portion increases as a pressure difference between both ends of the connecting portion increases, the non-linearity causing a volume flow rate of the ink to decrease as the pressure difference increases, the anisotropic property causing the volume flow rate of the ink backflow to decrease more than the volume flow rate of the ink refill flow as the pressure difference increases.

The converging regions may include surfaces tapered toward the supplying portion.

The expansion region may include an expansion surface extending at a right angle to a center axis of the connecting portion.

The backflow restrictor may include a plurality of converging regions and a plurality of expansion regions that are alternately formed.

The connecting portion may connect the ejecting portion and the supplying portion in a straight line.

A center axis of the connecting portion may have a curved shape.

The actuator may include a heat source heating the ink for creating a bubble in the ink, and the ejecting portion may eject the ink by growing the bubble in the same direction as the ink is ejected according to a top shooting method.

The foregoing and or other aspects of the present general inventive concept may also be achieved by providing an inkjet printhead including an ejecting portion including an ink chamber to store ink, a nozzle to eject the ink stored in the ink chamber, and an actuator to generate an ink ejecting force a supplying portion to refill the ink chamber with the ink a connecting portion to connect the ejecting portion and the supplying portion and a backflow restrictor formed at the connecting portion to create a higher flow resistance against an ink backflow to the supplying portion than against an ink refill flow to the ejecting portion, the backflow restrictor exhibiting a non-linearity and an anisotropic property when a volume flow of the ink through the connecting portion increases as a pressure difference between both ends of the connecting portion increases, the non-linearity causing a volume flow rate of the ink to decrease as the pressure difference increases, the anisotropic property causing the volume flow rate of the ink backflow to decrease more than the volume flow rate of the ink refill flow as the pressure difference increases.

The backflow restrictor may include surfaces repeatedly formed in a tapered fashion toward the supplying portion.

The backflow restrictor may further include an expansion surface between the tapered surfaces.

The foregoing and or other aspects of the present general inventive concept may also be achieved by providing an inkjet printhead including an ejecting portion having side walls to define an ink chamber to store ink that is to be ejected, a supply portion to refill the ink chamber with the ink, a connecting portion disposed between the ejecting portion and the supply portion to form a passage for the ink, and having an inclined surface inclined to have a first angle with respect to a center line of the passage and an expansion surface inclined to have a second angle greater than the first angle with respect to the center line of the passage, and a throat formed by the converging surface and the expansion surface to narrow the passage.

The inclined surface may be extended from a side of the ink chamber toward the throat to narrow the passage of the ink, and the expansion surface may be extended from the throat in a direction away from the center line of the passage to expand the passage.

The inclined surface may include a first end connected to the ink chamber and a second end connected to the throat spaced-apart from the center line by a first distance, and the expansion surface may include a third end connected to the throat and a fourth end spaced-apart from the center line by a second distance.

The inkjet printhead may further include another inclined surface disposed between the expansion surface and the supplying portion and inclined from the expansion surface to have a third angle.

The expansion surface and the another inclined surface may form an expansion region to control a pressure difference between the ink chamber and the supplying portion.

The inclined surface may form a converging region, and the expansion surface and the another inclined surface may form an expansion region, so as to reduce a back-flow and increase a refill-flow between the ink chamber and the supplying portion.

The second angle of the expansion surface may be about 90°.

The connecting portion may include a converging region defined by the inclined surface and an expansion region defined by the expansion surface; and the passage of the ink narrows in the converging region in a direction from the ejecting portion to the supplying portion and is widened in the expansion region.

The inclined surface may be extended from a side of the ink chamber toward the throat to narrow the passage of the ink, and the expansion surface may be extended from the throat to be connected to the supply portion.

The inclined surface may include a plurality of inclined surfaces; the expansion surface comprises a plurality of expansion surfaces, and the throat may include a plurality of throats each formed by the adjacent inclined surface and expansion surface.

The throats may be spaced-apart from the center line of the passage by a same distance.

The throats may be spaced-apart from the center line by a first distance, the plurality of expansion surfaces may include a first end connected to the corresponding throat and a second end connected to the corresponding inclined surface, and the second end of the respective expansion surface may be spaced-apart from the center line by a second distance.

The adjacent inclined surface and expansion surface may form a third angle at the corresponding throat, and the third angle may be smaller than the second angle.

The adjacent inclined surface and expansion surface may form a third angle between the adjacent throats, and the third angle may be smaller than the second angle.

The adjacent inclined surface and expansion surface between the adjacent throats may form an expansion region to generate a first turbulence current in a back-flow of the ink flowing from the ink chamber to the supplying portion and a second turbulence current in a refill-flow of the ink flowing from the supplying portion to the ink chamber.

The inclined surface may include a first inclined surface extended from a side of the ink chamber and a second inclined surface spaced-apart from the first inclined surface, and the throat may include a first throat formed by the first inclined surface and the expansion surface and a second throat formed by the second inclined surface and the supplying portion.

The inclined surface may include a first inclined surface extended from a side of the ink chamber and a second inclined surface spaced-apart from the first inclined surface, and the throat may include a first throat formed by the first inclined surface and the expansion surface and a second throat formed by the second inclined surface and the supplying portion.

The inclined surface may include a first inclined surface extended from a side of the ink chamber, a second inclined surface spaced-apart from the first inclined surface, and a third inclined surface spaced-apart from the first and second surfaces, the expansion surface may include a first expansion surface disposed between the first and second inclined surfaces and a second expansion surface disposed between the second and third inclined surfaces, and the throat may include a first throat formed by the first inclined surface and the first expansion surface and a second throat formed by the second inclined surface and the second expansion surface.

The third inclined surface may form an inlet formed between the connecting portion and the supplying portion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional inkjet printhead;

FIG. 2 is a sectional view illustrating a cross-section taken along line II-II′ of FIG. 1;

FIG. 3 is a cut-away view illustrating an inkjet printhead having an ejecting portion, a connecting portion, and a supplying portion according to an embodiment of the present general inventive concept;

FIG. 4A is a plan view illustrating the inkjet printhead of in FIG. 3 to illustrate expansion of a bubble therein;

FIG. 4B is a side sectional view illustrating FIG. 4A;

FIG. 4C is a graph illustrating a relationship between a volume flow and a pressure difference in the inkjet printhead of FIG. 4A;

FIG. 5A is a plan view illustrating the inkjet printhead of FIG. 3 to illustrate shrinkage of a bubble therein;

FIG. 5B is a side sectional view illustrating the inkjet printhead of FIG. 5A;

FIG. 5C is a graph illustrating a relationship between a volume flow and a pressure difference in the inkjet printhead of FIG. 5A;

FIG. 6A a plan view illustrating the inkjet printhead of FIG. 3 when a bubble disappears;

FIG. 6B is a side sectional view illustrating the inkjet printhead of FIG. 6A;

FIG. 6C is a graph illustrating a relationship between a volume flow and a pressure difference in the inkjet printhead of FIG. 6A;

FIGS. 7 through 10 are plan views illustrating an inkjet printhead having converging regions and expansion regions according to embodiments of the present general inventive concept;

FIG. 11 is a graph illustrating a relationship between a volume flow and a time in the inkjet printhead of FIGS. 7 through 10; and

FIG. 12 is a plan view illustrating an inkjet printhead having a straight or curved connecting portion according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

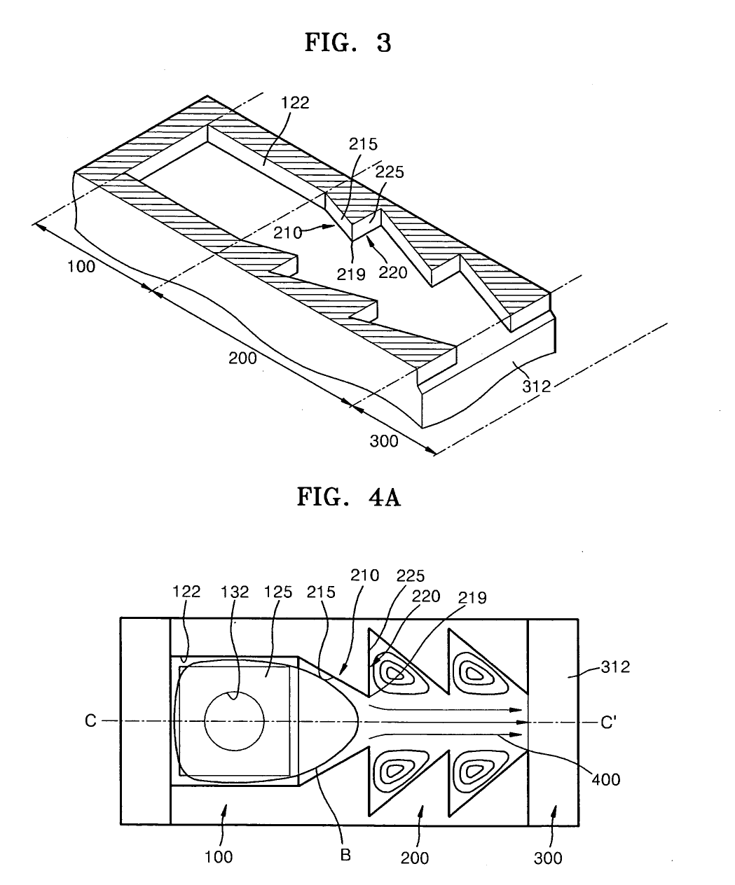

FIG. 3 is a cut-away view illustrating an inkjet printhead, including an ejecting portion 100, a connecting portion 200, and a supplying portion 300 according to an embodiment of the present general inventive concept. In FIG. 3, a top portion of the inkjet printhead is cut away to illustrate an ink flow channel in detail. The ejecting portion 100 fires ink to print an image. Therefore, the ejecting portion 100 includes an ink chamber 122, a nozzle (not illustrated), and an actuator (not illustrated). The ink chamber 122 stores the ink to be ejected through the nozzle by an ink-ejecting force generated by the actuator. The supplying portion 300 supplies the ink to the ejecting portion 100. To do this, the supplying portion 300 includes an ink feedhole 312 that connects an ink reservoir (not illustrated) to the connecting portion 200 to allowing the ink to flow therethrough. In the present embodiment, the connecting portion 200 connects the ejecting portion 100 and the supplying portion 300 in a straight line. The connecting portion 200 includes one or more converging regions 210 and one or more expansion regions 220. A tapered surface (inclined surface) 215 may define the converging regions 210, an expansion surface 225 may define the expansion regions 220, and a throat 219 is formed between the converging region 210 and the expansion region 220.

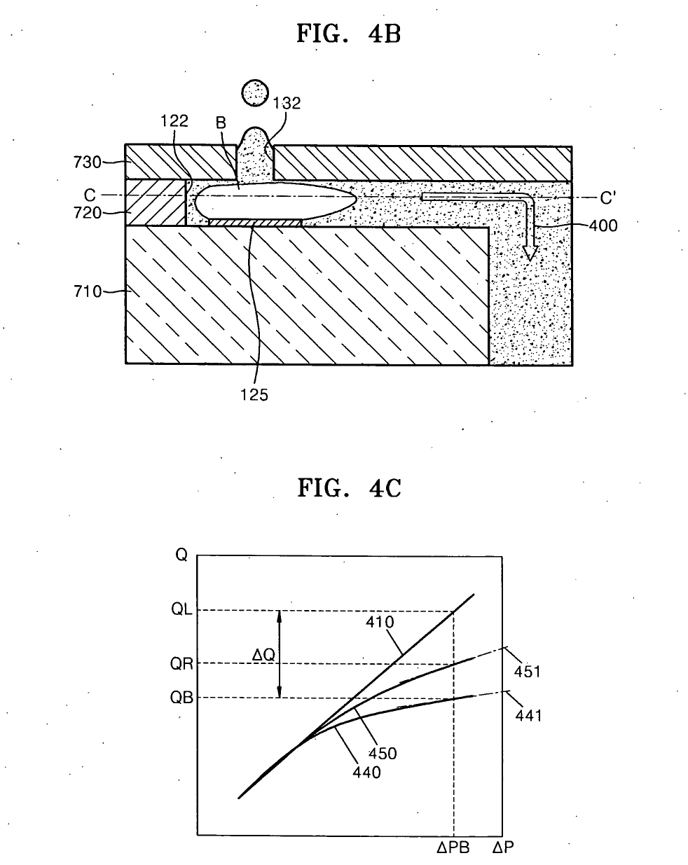

FIG. 4A is a plan view illustrating the inkjet printhead of FIG. 3 to further illustrate expansion of a bubble (B) in the printhead, and FIG. 4B is a side sectional view illustrating the inkjet printhead of FIG. 4A. Referring to FIGS. 3, 4A, and 4B, an actuator 125 generates the ink-ejecting force. In the present embodiment, a heater is used as the actuator 125 to generate the ink-ejecting force by creating and expanding the bubble (B). Though not illustrated, devices such as a piezoelectric unit, a shape memory alloy, or a supersonic motor can be used as the actuator 125. The inkjet printhead may be a top shooting type inkjet printhead in which the bubble (B) grows in a same direction as the ink is ejected. However, the inkjet printhead may be a side shooting type inkjet printhead in which a bubble grows in a direction perpendicular to the ink ejecting direction, or a back shooting type inkjet printhead in which a bubble grows in a direction opposite to the ink ejecting direction. That is, an installation position and structure of the actuator 125 can be changed in various ways.

The inkjet printhead includes a substrate 710, a chamber layer 720, and a nozzle layer 730 that are sequentially stacked. The substrate 710 includes the ink feedhole 312 in a portion corresponding to the supplying portion 300. The chamber layer 720 stacked on the substrate 710 includes the ink chamber 122, the actuator 125, and the supplying portion 300 that are formed by photolithography or the like. The nozzle layer 730 stacked on the chamber layer 720 includes a nozzle 132.

If the actuator 125 is operated, ink around the actuator 125 is heated up to a boiling point or higher, such that the bubble (B) can be created and expanded in the ink. For example, within 5˜10 μs after a starting point of an operation of the actuator 125, the bubble (B) expands and a pressure of the bubble (B) increases by tens of atmospheres. Around this pressure, ink is ejected out of the ink chamber 122 through the nozzle 132 and a portion of the ink also reversely flows from the ink chamber 122 to the supplying portion 300 through the connecting portion 200 as a back flow 400.

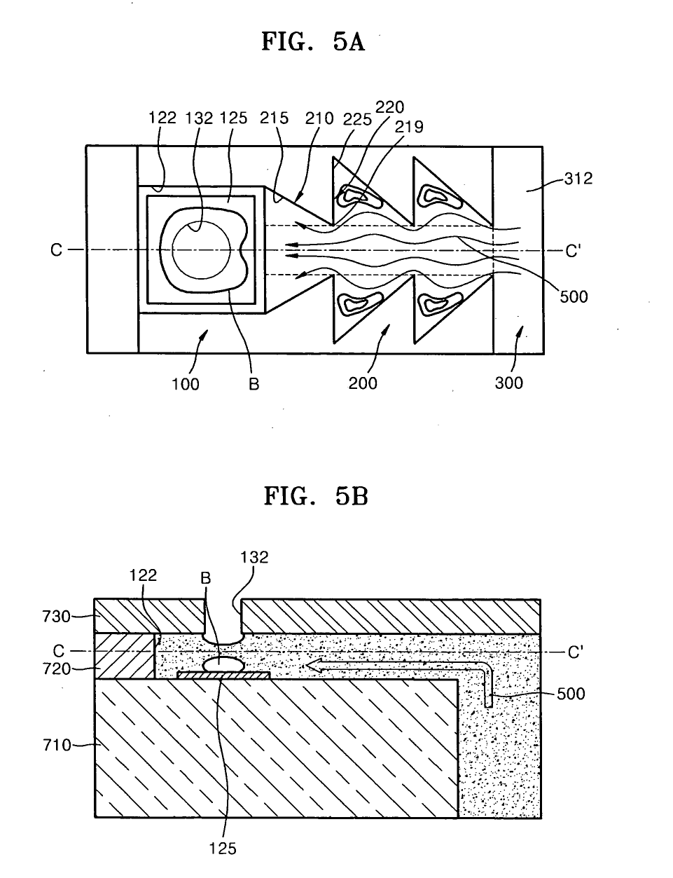

FIG. 5A is a plan view of the inkjet printhead illustrated in FIG. 3 to further illustrate shrinkage of the bubble (B), and FIG. 5B is a side sectional view illustrating the inkjet printhead of FIG. 5A. Referring to FIGS. 3-5B, if power to the actuator 125 is off, the bubble (B) shrinks and a pressure inside the ink chamber 122 decreases drastically. For example, within 10˜20 μs after the starting point of the operation of the actuator 125, the pressure of the bubble (B) decreases to only a few atmospheres as the bubble (B) shrinks. The pressure inside the connecting portion 200 becomes higher due to the expansion of the bubble (B) and becomes lower due to the shrinkage of the bubble (B). While the pressure of the connecting portion 200 decreases by the shrinkage of the bubble (B), the pressure of the connecting portion 200 becomes temporarily higher than the pressure of the ink chamber 122 of the ejecting portion 100. This pressure difference between the ejecting portion 100 and the connecting portion 200 during the shrinkage of the bubble (B) is a primary factor causing a refill flow 500 of ink from the ink feed hole 312 of the supplying portion 300 to the connecting portion 200.

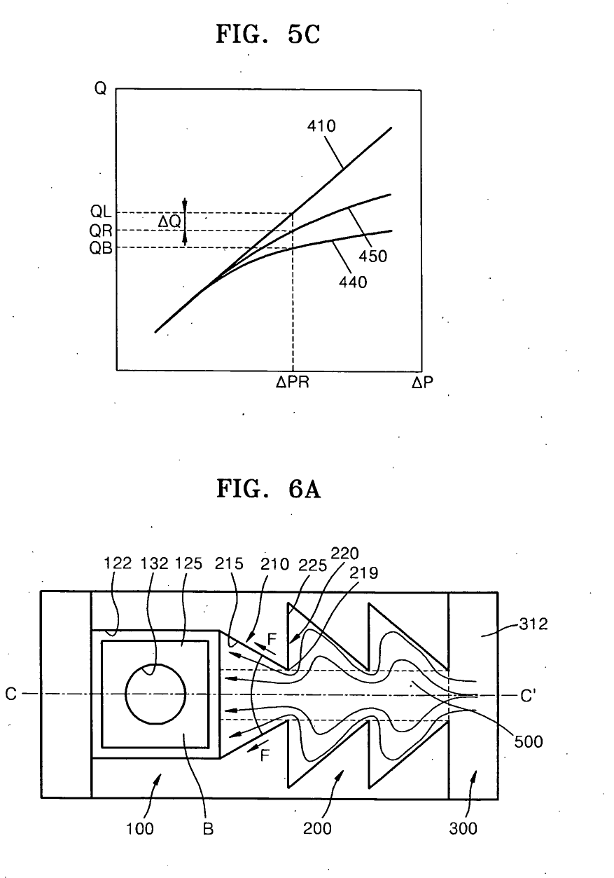

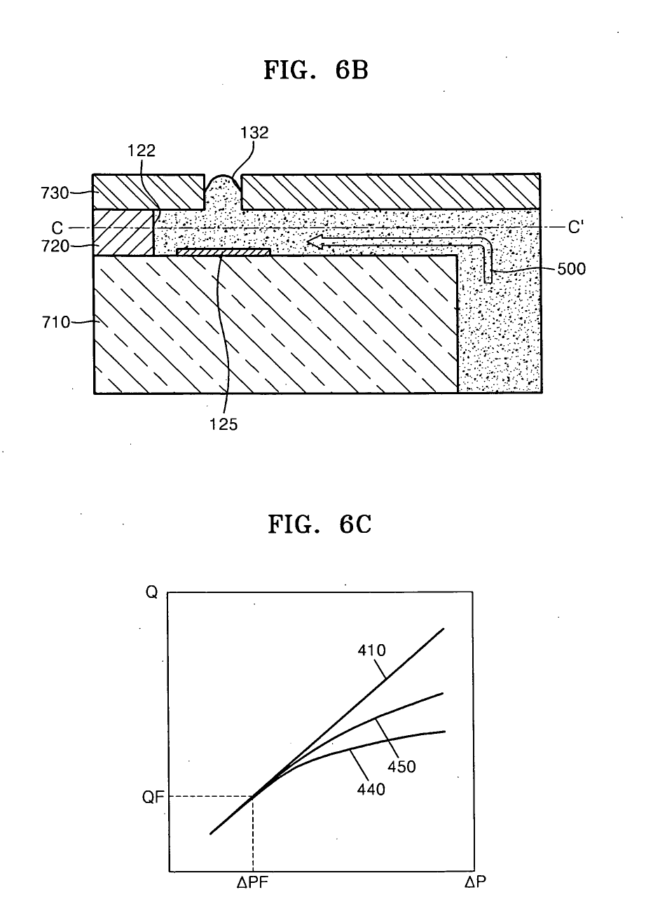

FIG. 6A is a plan view of the inkjet printhead illustrated in FIG. 3 to illustrate a state after the bubble (B) disappears, and FIG. 6B is a side sectional view illustrating the inkjet printhead of FIG. 6A. Referring to FIGS. 3-6B the bubble (B) completely disappears as the ink further cools after the actuator 125 is powered off. For example, within 10˜50 μs from the starting point of the operation of the actuator 125, the bubble (B) completely disappears and the pressure inside the ink chamber 122 decreases to about one atmosphere.

As the refill flow 500 progresses, the pressure of the connecting portion 200 decreases much more than that of FIG. 5A. After the pressures of the ink chamber 122 and the connecting portion 200 are almost equal to each other and measure close to an atmospheric pressure, the refill flow 500 further progresses by a capillary force linearly related to a surface tension of the ink in the nozzle 132.

FIG. 4C is a graph illustrating a relationship between a volume flow Q and a pressure difference ΔP when the bubble (B) expands. FIG. 5C is a graph illustrating the relationship between the volume flow Q and the pressure difference ΔP when the bubble (B) shrinks, and FIG. 6C is a graph illustrating the relationship between the volume flow Q and the pressure difference ΔP after the bubble (B) disappears completely. A structure and an operation of a backflow restrictor will now be described with reference to FIGS. 4A through 6C.

For the convenience of description, a contact region between the connecting portion 200 and the ejecting portion 100 will now be referred to as an outlet of the connecting portion 200, and a contact region between the connecting portion 200 and the supplying portion 300 as an inlet of the connecting portion 200. In FIGS. 4C, 5C, and 6C, each horizontal axis represents the pressure difference ΔP between the inlet and the outlet of the connecting portion 200, and each vertical axis represents the volume flow Q of ink passing through the connecting portion 200. If it is assumed that ink is an incompressible fluid, the pressure difference ΔP between the inlet and the outlet of the connecting portion 200 is substantially the same as the pressure difference ΔP between the ejecting portion 100 and the supplying portion 300. A flow resistance R is defined by Equation 1 below. The flow resistance R is an inverse of a volume flow rate (described later).

$$R = \frac{Δ P}{Q} \qquad [ Equation 1 ]$$

The backflow restrictor is provided in the connecting portion 200. The backflow restrictor applies a much greater flow resistance R to a backflow 400 directed to the supplying portion 300 than it applies to the refill flow 500 directed to the ejecting portion 100, thereby restricting the backflow 400. The backflow restrictor includes converging regions 210 narrowing toward the supplying portion 300, and expansion regions 220 expanding from the converging region 210 toward the supplying portion 300.

To apply the large flow resistance to the backflow 400, the expansion regions 220 and the converging regions 210 have different slopes. The expansion regions 220 are formed between the converging regions 210 at a greater angle than the converging regions 210. A cross section of the expansion regions 220 expands at a higher rate than the cross section of the converging regions 210 decreases. In other words, the backflow restrictor includes a series of surfaces 215 tapered toward the supplying portion 300, a series of expansion surfaces 225 between the tapered surfaces 215, and throats 219 between the tapered surfaces 215 and the expansion surfaces 225. The expansion surfaces 225 may extend from the throats 219 at a right angle to the center line C-C′ of the connecting portion 200. The converging regions 210 and the expansion regions 220 are alternately formed. The numbers of the converging regions 210 and the expansion regions 220 are not limited.

That is, the connecting portion 200 includes a passage formed with the converging regions 210 and the expansion regions 220 defined by the tapered surface 215 and the expansion surface 225, respectively. The passage narrows along the converging regions 210 toward the throat 219 and is broadened along the expansion regions 220 from the throat 219. The tapered surface 215 extends from a side surface of the ink chamber 122 and is inclined to have an angle with the center line C-C′. The expansion surface 225 has another angle greater than the angle of the tapered surface 215 with respect to the center line C-C′. As illustrated in FIG. 4A the tapered surface 215 and the expansion surface 225 are arranged to form a plurality of the throats 219. A portion of the passage disposed at the throat 219 is narrower than a distance between side surfaces of the ink chamber 122 and another position of the passage disposed at end positions of the expansion region 220 away from the throat 219 is broader than the distance of the side surface of the ink chamber 122.

The backflow 400 runs toward the supplying portion 300 through the connecting portion 200 where the backflow 400 flows through the converging regions 210 and the expansion regions 220 in turns. While passing through the connecting portion 200, the backflow 400 is gradually compressed by the converging regions 210 and expands suddenly at the expansion regions 220, such that the backflow 400 becomes a high-velocity flow having a large Reynolds number, velocity, and degree of turbulence. In contrast, the refill flow 500 runs toward the ejecting portion 100 through the connecting portion 200 where the refill flow 500 flows through the expansion regions 220 and the converging regions 220 in turns, such that the refill flow 500 become a low-velocity flow having a smaller Reynolds number, velocity, and degree of turbulence than those of the backflow 400.

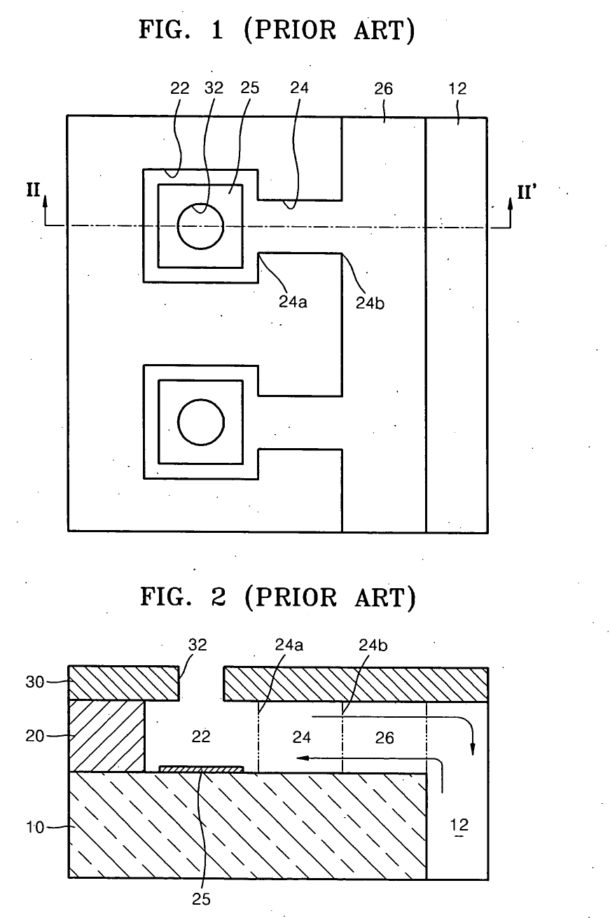

In FIGS. 4C, 5C, and 6C, reference numeral 410 denotes first curves having a straight shape and disposed topmost. The first curves 410 represent a linear relationship between the ink volume flow Q and the pressure difference ΔP of ink flow in a conventional ink flow channel illustrated in FIG. 1. Here, a flow resistance R of the conventional ink flow channel has a constant value equal to the inverse of a slope of the first curve 410. Reference numeral 450 denotes second curves plotted under the first curves 410, illustrating the relationship between the ink volume flow Q and the pressure difference ΔP of the refill flow 500 in the ink flow channel of the present general inventive concept. Reference numeral 440 denotes third curves plotted under the second curves 450, illustrating the relationship between ink volume flow Q and pressure difference ΔP of the backflow 400 in the ink flow channel of the present embodiment.

The second and third curves 450 and 440 plotted for the ink flow channel of the present embodiment illustrates that the flow resistance R of the ink flow channel is not constant. The flow resistance R increases as the pressure difference ΔP increases. That is, an ink volume flow rate such as a slope of a tangential line to the second curve 450 and the third curve 440 at each point corresponding to the inverse of the flow resistance R decreases non-linearly as the pressure difference ΔP increases.

A non-linearity of the ink volume flow rate results from the fact that an inertia loss of the ink flow caused by the backflow restrictor increases as the pressure difference ΔP increases. Here, the term “inertia loss” is used to denote the inertia energy, such as kinetic and potential energies of the ink flow which is not conserved before and after the backflow restrictor. When compared with the conventional linear ink flow channel illustrated in FIG. 1, the non-linear ink flow channel of the present embodiment has a large flow resistance and allows the backflow of ink to decrease drastically as the pressure difference increases. Although, theoretically, the inertia loss is the inertial energy loss of the ink flow, we define the “inertia loss” as the ink flow volume difference ΔQ between the ink flow volume in the present embodiment and the ink flow volume in the related art for convenience of a description. The inertia loss ΔQ, corresponding to the ink flow volume difference increases in proportion P to the velocity and the Reynolds number of the ink flow, and the pressure difference between the ejecting portion 100 and the supplying portion 300.

The backflow restrictor exhibits an anisotropic property such that the backflow 400 is supposed to a larger inertia loss than the refill flow 500. The third curve 440 is plotted under the second curve 450 because the flow resistance R varies depending on a direction of ink flow. The flow resistance R is larger against the backflow 400 than the refill flow 500. Therefore, the relationship between pressure difference ΔP and ink volume flow ΔQ is anisotropic with respect to the direction of the ink flow. The inertia loss of the refill flow is smaller than that of the backflow 400. For example, referring to FIG. 4C, an ink volume flow rate 441 of the backflow 400 at a point ΔPB which corresponds to the slope of the tangential line of the third curve 440 at the point ΔPB is smaller than an ink volume flow rate 451 of the refill flow 500 at the point ΔPB which corresponds to the slope of the tangential line of the second curve 450 at the point ΔPB. As the second curve 450 approaches the first curve 410 and deviates from the third curve 440, the inertia loss of the refill flow 500 can be decreased.

Referring to FIG. 4C illustrating the relationship between a volume backflow and the pressure difference during the expansion of a bubble, ΔPB denotes the pressure difference between the ejecting portion 100 and the supplying portion 300 when the bubble expands, QL denotes a volume flow of the backflow in the conventional ink flow channel illustrated in FIG. 1, QB denotes the volume flow of the backflow in the ink flow channel of the present embodiment in which the backflow restrictor is formed, and QR denotes a volume flow of the refill flow 500 directed to the ejecting portion 100 immediately after the bubble starts to shrink. If it is assumed that expansion of a bubble generates the same pressure difference ΔPB, the volume flow QB of the backflow in the ink flow channel of the present embodiment is smaller than the volume flow QL of the backflow in the conventional ink flow channel, because the backflow restrictor of the present embodiment is formed in a non-linear fashion as described above.

Referring to FIG. 5C illustrating the relationship between the volume flow of the refill flow 500 and the pressure difference during the shrinkage of a bubble, ΔPR denotes the pressure difference between the ejecting portion 100 and the supplying portion 300 when the bubble shrinks, QL denotes a volume flow of the refill flow in the conventional ink flow channel, and QR denotes a volume flow of the refill flow in the ink flow channel of the present embodiment. When it is assumed that the shrinkage of the bubble generates the same pressure difference ΔPR, the volume flow QR of the refill flow in the ink flow channel of the present embodiment is smaller than the volume flow QL of the refill flow in the conventional ink flow channel. However, since the pressure difference ΔPR caused by the shrinkage of the bubble is quite smaller than the pressure difference ΔPB as illustrated in FIG. 4C caused by the expansion of the bubble, the decrease of the volume refill flow caused by the flow resistance difference is negligible when compared with the decrease of the backflow 400 (referring to FIG. 4B).

Referring to FIG. 6C illustrating the relationship between volume refill flow and pressure difference after the bubble disappears, ΔPF denotes the pressure difference (caused by the surface tension of ink in the nozzle 132) between the ejecting portion 100 and the supplying portion 300 after the bubble disappears. Since the pressure difference ΔPF and inertia loss are very small, volume flow QF of the refill flow is the same in the conventional ink flow channel and in the ink flow channel of the present embodiment.

The ink refill efficiency of the ink flow channel of the present embodiment will now be described again with reference to FIGS. 4C, 5C, and 6C. The amount of ink to be refilled in the ink chamber 122 is determined as the sum of the amount of ink ejected out of the ink chamber 122 and the amount of the ink backflow. In the present embodiment, the backflow 400 reduces significantly because the flow resistance R is high against the backflow 400, so that the overall refill efficiency and time can be improved over the related although it is assumed that the refill flow 500 decreases a little.

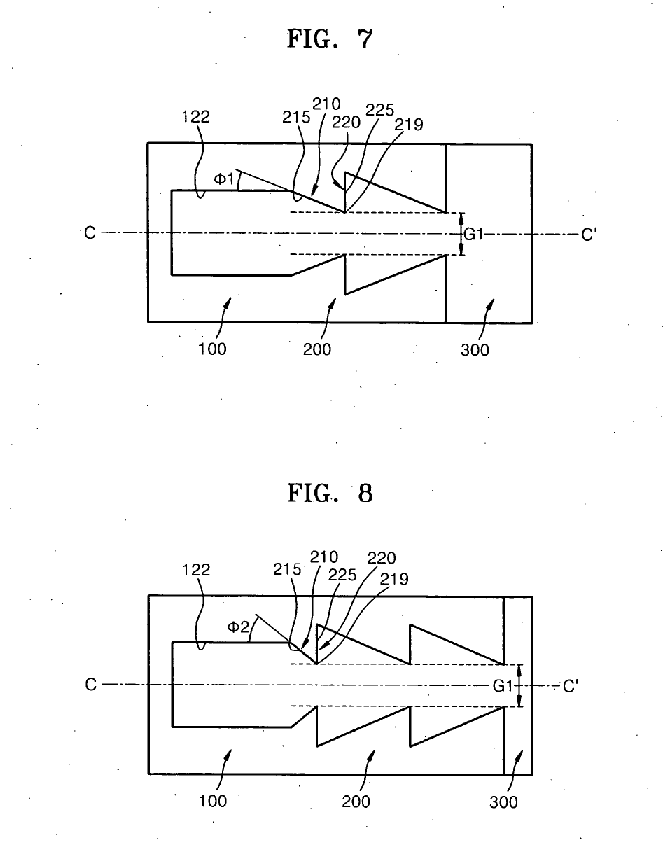

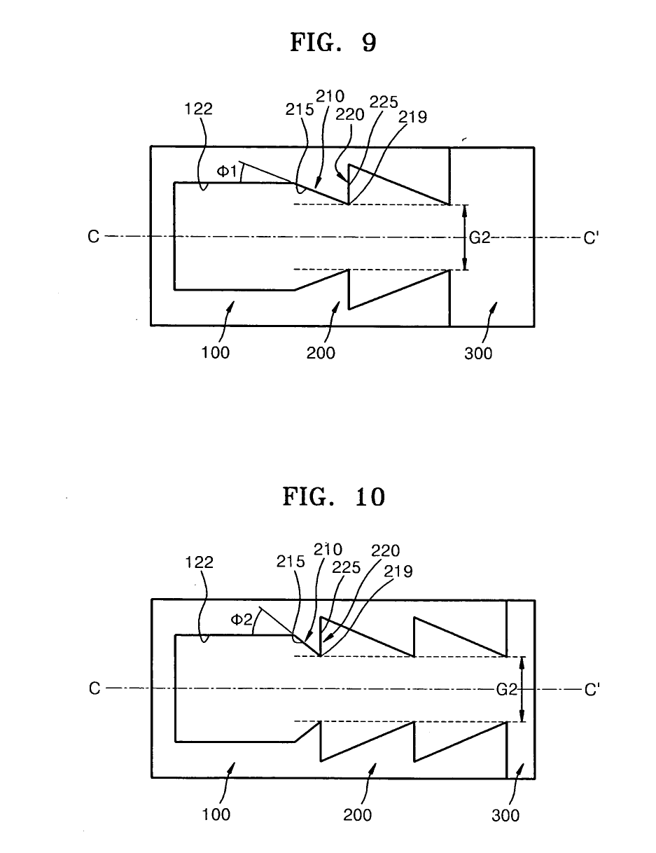

FIGS. 7 through 10 are plan views illustrating converging regions 210 and expansion regions 220 according to embodiments of the present general inventive concept. For the convenience of description, an ink flow channel illustrated in FIG. 7 is referred to as a first embodiment, an ink flow channel illustrated in FIG. 8 as a second embodiment, an ink flow channel illustrated in FIG. 9 as a third embodiment, and an ink flow channel illustrated in FIG. 10 as a fourth embodiment. The first through fourth embodiments can be distinguished by converging angles (φ1=30°, φ2=45°) of the converging regions 210, the number of the converging regions 220 (two or three), and the sizes of throats 219 (G1=12 μm, G2=14 μm).

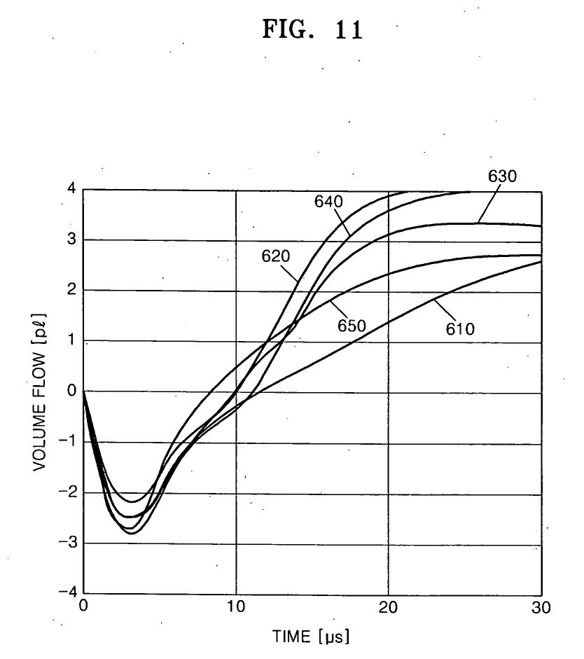

FIG. 11 is a graph plotted using a numerical analysis to explain a relationship between the volume flow and time in the first through fourth embodiments of FIGS. 7 through 10. Table 1 below illustrates results obtained by numerically analyzing the first and fourth embodiments, and table 2 illustrated percentage values obtained by comparing the results of table 1 with those obtained from the conventional ink flow channel. Reference numerals 610, 620, 630, and 640 denote volume flow curves in the first through fourth embodiments, respectively. Reference numeral 650 denotes a volume flow curve obtained from the conventional ink flow channel. With respect to a vertical axis denoting the volume flow, a negative sign represents backflow and a positive sign represents refill flow.

TABLE 1

| | | | First | Second | Third | Fourth |
|---|---|---|---|---|---|---|
| | units | Related art | embodiment | embodiment | embodiment | embodiment |
| Ink droplet | (m/s) | 15.5 | 15.6 | 15.3 | 15.2 | 15.5 |
| ejecting speed | | | | | | |
| Ink droplet | (pl: pico | 2.2 | 2.2 | 2.2 | 2.2 | 2.2 |
| volume | liter) | | | | | |
| Maximum | (pl) | 2.7 | 2.5 | 2.1 | 2.8 | 2.5 |
| volume flow of | | | | | | |
| backflow | | | | | | |
| Refill flow rate | (pl/μs) | 0.2 | 0.16 | 0.39 | 0.35 | 0.37 |
| Refill time | (μs: micro | 23.1 | 29.6 | 14.7 | 16.8 | 16 |
| | second) | | | | | |

TABLE 2

| | | | First | Second | Third | Fourth |
|---|---|---|---|---|---|---|
| | units | Related art | embodiment | embodiment | embodiment | embodiment |
| Ink droplet | % | 100 | 100.3 | 98.3 | 98 | 99.6 |
| ejecting speed | | | | | | |
| Ink droplet | % | 100 | 100 | 99.9 | 99.7 | 100 |
| volume | | | | | | |
| Maximum | % | 100 | 90.8 | 78.9 | 102 | 91.1 |
| volume flow of | | | | | | |
| backflow | | | | | | |
| Refill flow rate | % | 100 | 79.5 | 194.9 | 177.2 | 187.6 |
| Refill time | % | 100 | 128.3 | 63.9 | 72.6 | 69.3 |

Referring to FIG. 11, each volume flow curve has a minimal point between 1 μs and 10 μs, where the volume backflow is maximal. Referring to table 2, the ink droplet ejecting speed and ink droplet volume are substantially the same as in the related art, and the maximum volume flow of backflow is about 78.9-102% lower than in the related art.

In the range of about 10 through 30 μs, each volume flow curve is plotted above a zero volume flow line, which represents the refill flow. Referring to table 2 a refill flow rate (refill volume per unit time) is approximately higher than in the related art (maximally, 194.9%), and the refill time is shorter than in the related art. The volume flow of the refill flow is also increased than in the related art (this can be known by comparing the volume flow curves 620, 630, and 640 with the volume flow curve 650 of the related art). Therefore, it is apparent that the backflow restrictor of the present embodiment provides an improved refill efficiency as well as a backflow restricting effect since it takes shorter time for refilling the ink chamber 122.

In describing the volume flow of the refill flow with reference to FIGS. 4C, 5C, and 6C, it is assumed that the pressure difference between both ends of the connecting portion 200 is the same in the embodiments of the present embodiment and in the related art, for the convenience of description. However, in the numerical analysis of FIG. 11 and Tables 1 and 2, the same pressure difference condition which is assumed artificially is not applied. Instead, the volume flow of the refill flow is compared under real operating conditions according to the expansion, shrinkage, and extinction of the bubble.

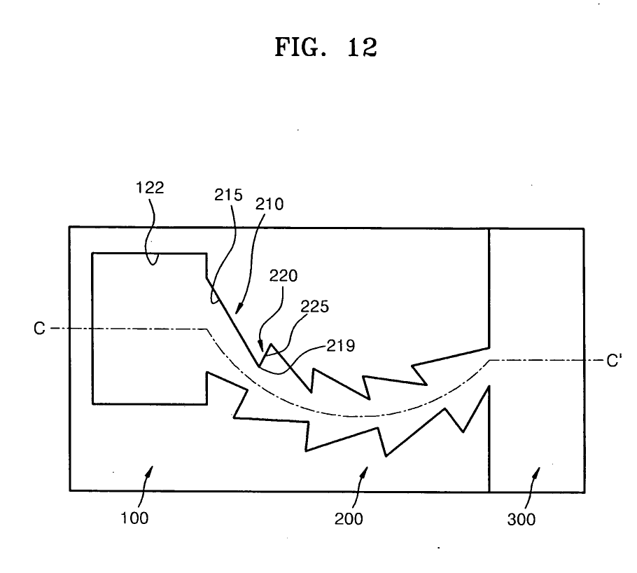

FIG. 12 is a plan view illustrating an inkjet printhead having a connecting portion 200 according to an embodiment of the present embodiment. The connecting portion 200 illustrated in FIG. 12 may have a straight or curved center line C-C′. In this embodiment, the change in the shape of the connecting portion 200 does not substantially affect the function of a backflow restrictor formed in the connecting portion 200 when compared with the previously described embodiments. The backflow restrictor includes converging regions 210 and expansion regions 220 that are alternately formed, such that the flow resistance of the backflow restrictor can be increased against the backflow. The respective throats 219 are disposed along the curved center line. The converging regions 210 defined by the respective inclined surfaces 215 and the expansion regions 220 defined by the respective expansion surfaces are inclined with respect to the curved center line such that the passage narrows toward the supplying portion 300 in the respective converging regions 210 and is widened in the respective expansion regions 220. Since the backflow restrictor has substantially the same configuration, a detailed description of the restrictor of the current embodiment will be omitted.

As described above, according to the inkjet printhead of the present general inventive concept, ink backflow to the supplying portion is restricted, so that the energy efficiency of the actuator can be improved and thus the size of the actuator can be reduced. Further, the ink refill can be performed at a higher efficiency in a shorter time, and the driving frequency of the inkjet printhead can be increased, thereby realizing an inkjet printhead that fires ink at a high speed with less power.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
an ejecting portion including an ink chamber to store ink, a nozzle to eject the ink stored in the ink chamber, and an actuator to generate an ink ejecting force;
a supplying portion to refill the ink chamber with the ink;
a connecting portion to connect the ejecting portion and the supplying portion; and
a backflow restrictor formed at the connecting portion to create a higher flow resistance against an ink backflow to the supplying portion than against an ink refill flow to the ejecting portion, the backflow restrictor including a converging region and an expansion region that are sequentially formed, the converging region gradually converging toward the supplying portion, the expansion region suddenly expanding toward the supplying portion when compared with the converging region.

2. The inkjet printhead of claim 1, wherein the backflow restrictor comprises another converging region, and the expansion region is formed between the converging region and the another converging region and has a steeper slope than that of the converging regions.

3. The inkjet printhead of claim 2, wherein the backflow restrictor exhibits a non-linearity and an anisotropic property when a volume flow of the ink through the connecting portion increases as a pressure difference between both ends of the connecting portion increases, the non-linearity causing a volume flow rate of the ink to decrease as the pressure difference increases, the anisotropic property causing the volume flow rate of the ink backflow to decrease more than the volume flow rate of the ink refill flow as the pressure difference increases.

4. The inkjet printhead of claim 3, wherein the converging regions comprise surfaces tapered toward the supplying portion.

5. The inkjet printhead of claim 4, wherein the expansion region comprises an expansion surface extending at a right angle to a center axis of the connecting portion.

6. The inkjet printhead of claim 1, wherein the converging region and the expansion region comprise a plurality of converging regions and a plurality of expansion regions, respectively, that are alternately formed.

7. The inkjet printhead of claim 1, wherein the connecting portion connects the ejecting portion and the supplying portion in a straight line.

8. The inkjet printhead of claim 1, wherein a center axis of the connecting portion has a curved shape.

9. The inkjet printhead of claim 1, wherein the actuator comprises:
a heat source to heat the ink to create a bubble in the ink; and
the ejecting portion ejects the ink by growing the bubble in the same direction as the ink is ejected according to a top shooting method.

10. An inkjet printhead comprising:
an ejecting portion including an ink chamber to store ink, a nozzle to eject the ink stored in the ink chamber, and an actuator to generate an ink ejecting force;
a supplying portion to refill the ink chamber with ink;
a connecting portion to connect the ejecting portion and the supplying portion; and
a backflow restrictor formed at the connecting portion to create a higher flow resistance against an ink backflow to the supplying portion than against an ink refill flow to the ejecting portion, the backflow restrictor exhibiting a non-linearity and an anisotropic property when a volume flow of the ink through the connecting portion increases as a pressure difference between both ends of the connecting portion increases, the non-linearity causing a volume flow rate of the ink to decrease as the pressure difference increases, the anisotropic property causing the volume flow rate of the ink backflow to decrease more than the volume flow rate of the ink refill flow as the pressure difference increases.

11. The inkjet printhead of claim 10, wherein the backflow restrictor comprises surfaces repeatedly formed in a tapered fashion toward the supplying portion.

12. The inkjet printhead of claim 11, wherein the backflow restrictor further comprises an expansion surface between the tapered surfaces.

13. The inkjet printhead of claim 10, wherein the connecting portion connects the ejecting portion and the supplying portion in a straight line.

14. The inkjet printhead of claim 10, wherein a center axis of the connecting portion has a curved shape.

15. The inkjet printhead of claim 10, wherein the actuator comprises:
a heat source heating the ink to create a bubble in the ink, and
the ejecting portion ejects the ink by growing the bubble in the same direction as the ink is ejected according to a top shooting method.

16. An inkjet printhead comprising:
an ejecting portion having side walls to define an ink chamber to store ink that is to be ejected;
a supply portion to refill the ink chamber with the ink;
a connecting portion disposed between the ejecting portion and the supply portion to form a passage for the ink, and having an inclined surface inclined to have a first angle with respect to a center line of the passage and an expansion surface inclined to have a second angle greater than the first angle with respect to the center line of the passage; and
a throat formed by the converging surface and the expansion surface to narrow the passage.

17. The inkjet printhead of claim 16, wherein:
the inclined surface is extended from a side of the ink chamber toward the throat to narrow the passage of the ink; and
the expansion surface is extended from the throat in a direction away from the center line of the passage to expand the passage.

18. The inkjet printhead of claim 16, wherein:
the inclined surface comprises a first end connected to the ink chamber and a second end connected to the throat spaced-apart from the center line by a first distance; and
the expansion surface comprises a third end connected to the throat and a fourth end spaced-apart from the center line by a second distance.

19. The inkjet printhead of claim 16, further comprising:
another inclined surface disposed between the expansion surface and the supplying portion and inclined from the expansion surface to have a third angle.

20. The inkjet printhead of claim 16, wherein the expansion surface and the another inclined surface form an expansion region to control a pressure difference between the ink chamber and the supplying portion.

21. The inkjet printhead of claim 16, wherein the inclined surface forms a converging region, and the expansion surface and the another inclined surface form an expansion region, so as to reduce a back-flow and increase a refill-flow between the ink chamber and the supplying portion.

22. The inkjet printhead of claim 16, wherein the second angle of the expansion surface is about 90°.

23. The inkjet printhead of claim 16, wherein:
the connecting portion comprises a converging region defined by the inclined surface and an expansion region defined by the expansion surface; and
the passage of the ink narrows in the converging region in a direction from the ejecting portion to the supplying portion and is widened in the expansion region.

24. The inkjet printhead of claim 16, wherein the inclined surface is extended from a side of the ink chamber toward the throat to narrow the passage of the ink, and the expansion surface is extended from the throat to be connected to the supply portion.

25. The inkjet printhead of claim 16, wherein:
the inclined surface comprises a plurality of inclined surfaces;
the expansion surface comprises a plurality of expansion surfaces; and
the throat comprises a plurality of throats each formed by the adjacent inclined surface and expansion surface.

26. The inkjet printhead of claim 25, wherein the throats are spaced-apart from the center line of the passage by a same distance.

27. The inkjet printhead of claim 25, wherein:
the throats are spaced-apart from the center line by a first distance;
the plurality of expansion surfaces comprise a first end connected to the corresponding throat and a second end connected to the corresponding inclined surface; and
the second end of the respective expansion surface is spaced-apart from the center line by a second distance.

28. The inkjet printhead of claim 25, wherein the adjacent inclined surface and expansion surface form a third angle at the corresponding throat, and the third angle is smaller than the second angle.

29. The inkjet printhead of claim 25, wherein the adjacent inclined surface and expansion surface form a third angle between the adjacent throats, and the third angle is smaller than the second angle.

30. The inkjet printhead of claim 25, wherein the adjacent inclined surface and expansion surface between the adjacent throats form an expansion region to generate a first turbulence current in a back-flow of the ink flowing from the ink chamber to the supplying portion and a second turbulence current in a refill-flow of the ink flowing from the supplying portion to the ink chamber.

31. The inkjet printhead of claim 16, wherein:
the inclined surface comprises a first inclined surface extended from a side of the ink chamber and a second inclined surface spaced-apart from the first inclined surface; and
the throat comprises a first throat formed by the first inclined surface and the expansion surface and a second throat formed by the second inclined surface and the supplying portion.

32. The inkjet printhead of claim 16, wherein:
the inclined surface comprises a first inclined surface extended from a side of the ink chamber and a second inclined surface spaced-apart from the first inclined surface; and
the throat comprises a first throat formed by the first inclined surface and the expansion surface and a second throat formed by the second inclined surface and the supplying portion.

33. The inkjet printhead of claim 16, wherein:
the inclined surface comprises a first inclined surface extended from a side of the ink chamber, a second inclined surface spaced-apart from the first inclined surface, and a third inclined surface spaced-apart from the first and second surfaces;
the expansion surface comprises a first expansion surface disposed between the first and second inclined surfaces and a second expansion surface disposed between the second and third inclined surfaces; and
the throat comprises a first throat formed by the first inclined surface and the first expansion surface and a second throat formed by the second inclined surface and the second expansion surface.

34. The inkjet printhead of claim 33, wherein the third inclined surface forms an inlet formed between the connecting portion and the supplying portion.
